(19) United States
(12) Patent Application Publication
(10) Pub. No.: US 2021/0131808 A1
(43) Pub. Date: May 6, 2021

(54) METHOD FOR RECONSTRUCTING THE MOVEMENT OF AN INDIVIDUAL AND THE SIGNAL MAP OF A LOCATION

(71) Applicant: GIPSTECH S.R.L., Rende (IT)

(72) Inventors: Gaetano D'AQUILA, Rende (IT); Giuseppe CUTRI', Rende (IT); Giuseppe FEDELE, Rende (IT); Luigi D'ALFONSO, Rende (IT)

(21) Appl. No.: 17/057,352

(22) PCT Filed: May 15, 2019
(86) PCT No.: PCT/IB2019/054031

§ 371 Date: Nov. 20, 2020

(30) Foreign Application Priority Data
May 22, 2018 (IT) 102018000005593

(51) Int. Cl. G01C 21/20; G01C 22/00

(52) U.S. Cl. CPC G01C 21/206; G01C 22/006

(57) ABSTRACT

Described is a process for reconstructing the movement of an individual who walks inside a space and who carries a device equipped with inertial sensors and a virtual representation (M) of the space. The process comprises: —an acquisition step of a first reference position (Pr1) and by choice: a first reference direction (vr1) associated with the first reference position (Pr1) or a second reference position (Pr2); —a detection step which comprises detecting, by means of the inertial sensors, a direction of movement for each step made by the individual; —a reconstruction step which comprises forming a trajectory (100) of the path of the individual, as a sequence of vectors (V1, V2, Vm); —an estimation step. The estimation step comprises positioning the trajectory (100) in such a way that, selectively: the staring point (Po) coincides with the first reference position (Pr1) and the arrival point (Pm) coincides with the second reference position (Pr2); or the starting point (Po), or the arrival point (Pm), coincides with the first reference position (Pr1) and the assigned direction (v1) of the first vector (V1), or the assigned direction (vm) of the last vector (Vm),

This invention relates to a process for reconstructing the movement of an individual and the signal map of a location.

In particular, the invention is directed at allowing the reconstruction of a starting position, an arrival position or the trajectory of movement of an individual who moves in a space in which it is not possible to use or the main aim is not to use a satellite geolocation system.

In the field of processes for geolocation inside a building, a process is currently known which comprises detecting ambient signals during the movement of an individual inside a building and geolocating the individual in the positions of a virtual representation to which the same ambient signals which have been obtained during a separate step for mapping the building substantially correspond.

The process in fact requires a step for mapping the building which consists in associating, with the positions of a virtual representation of the building, the ambient signals which are detected in the corresponding positions of the space itself.

The problem at the basis of this invention is to provide a process for reconstructing the movement of an individual which allows a prior mapping of the space in which the individual moves to be avoided.

The main aim of the invention is to make a process for reconstructing the movement of an individual which resolves this problem.

The aim of the invention is to provide a process for reconstructing the movement of an individual which can be implemented in a computer program which requires reduced calculation resources to immediately provide to a user with navigation information which is useful for reaching a predetermined position in the space in which the individual moves.

Another aim of the invention consists in making a process for reconstructing the movement of an individual which can be implemented in a computer program which, with the calculation resources available, allows a user to be provided with navigation information which is useful for reaching said position in a simpler and faster manner than that of the traditional process described above.

A further aim of the invention is to provide a method which allows a mapping of the natural or artificial signals present in the space to be actuated and a simultaneous localization (SLAM, Simultaneous Localization and Mapping) of the individual inside the space in which the individual moves.

This aim, as well as these and other aims which will emerge more fully below, are attained by a process for reconstructing the movement of an individual which can be implemented in a program according to appended claim 1. Detailed features of a process for reconstructing the movement of an individual according to the invention are indicated in the dependent claims. Further features and advantages of the invention will emerge more fully from the description of a preferred but not exclusive embodiment of a process for reconstructing the movement of an individual according to the invention, illustrated by way of non-limiting example in the accompanying drawings, in which:

FIG. 1 illustrates an implementation of an acquisition step of a process according to the invention with respect to a virtual representation of a space;

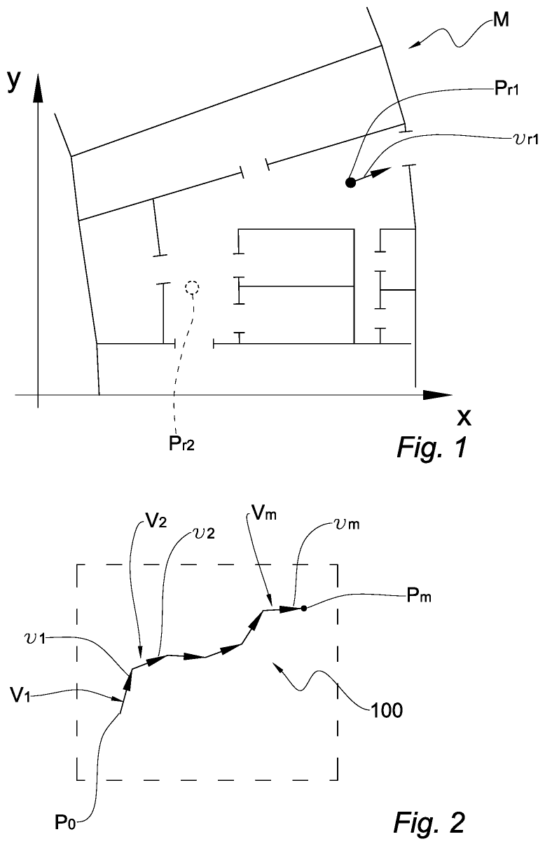

FIG. 2 illustrates an example of a trajectory resulting from the implementation of the step for acquiring the process for reconstructing the movement of an individual, according to the invention;

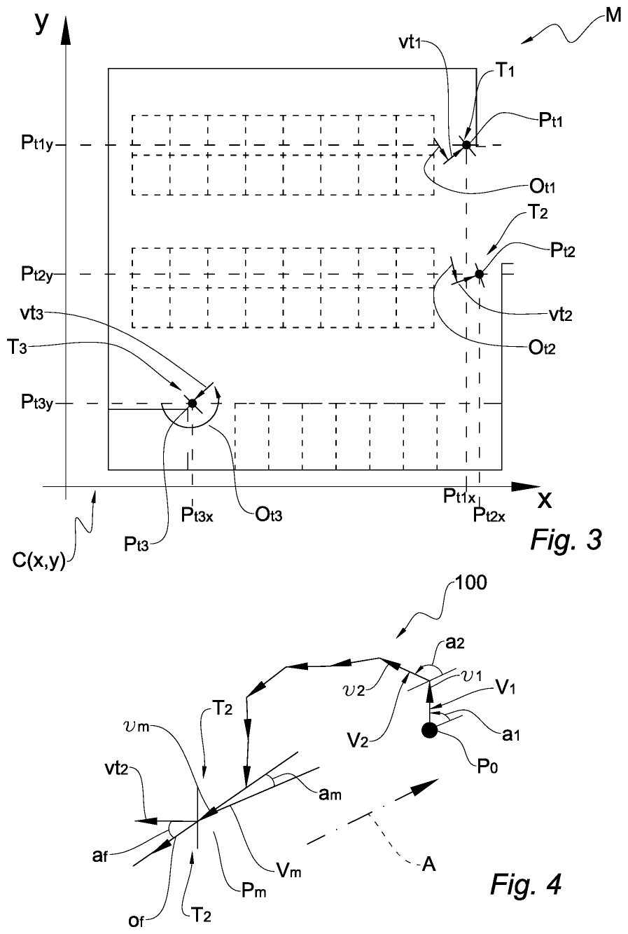

FIG. 3 illustrates an example of the step for preparing the process according to the invention;

FIG. 4 illustrates an example of the step for estimating the process according to the invention;

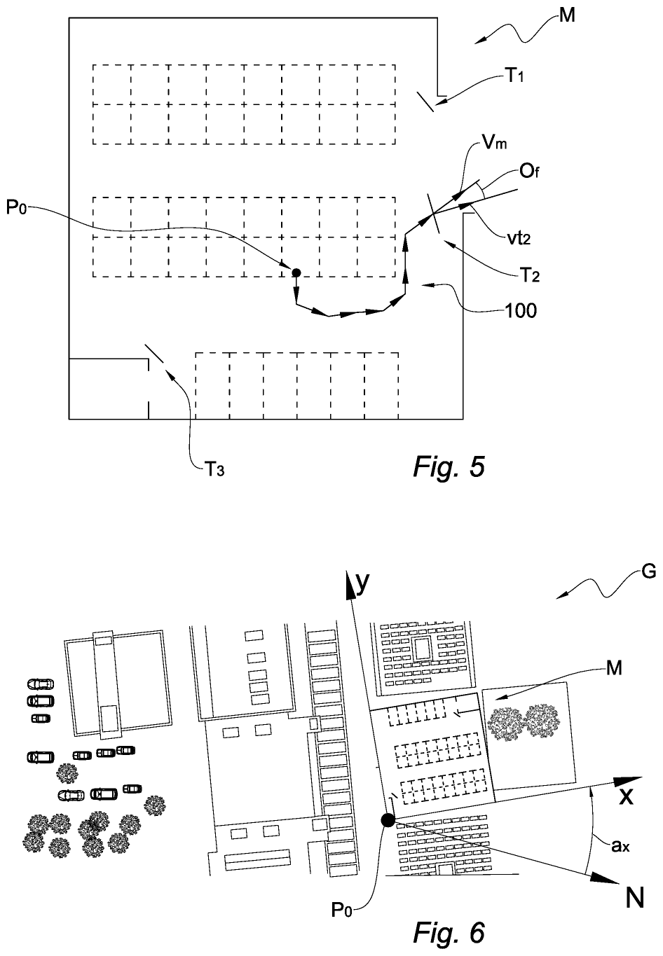

FIG. 5 illustrates an example of reconstructing a starting point of the trajectory of FIG. 2 in a virtual representation of a space by implementing the step for estimating the process for reconstructing the movement of an individual, according to the invention;

FIG. 6 illustrates and example of geolocation of the virtual representation of FIG. 5 in a global virtual representation;

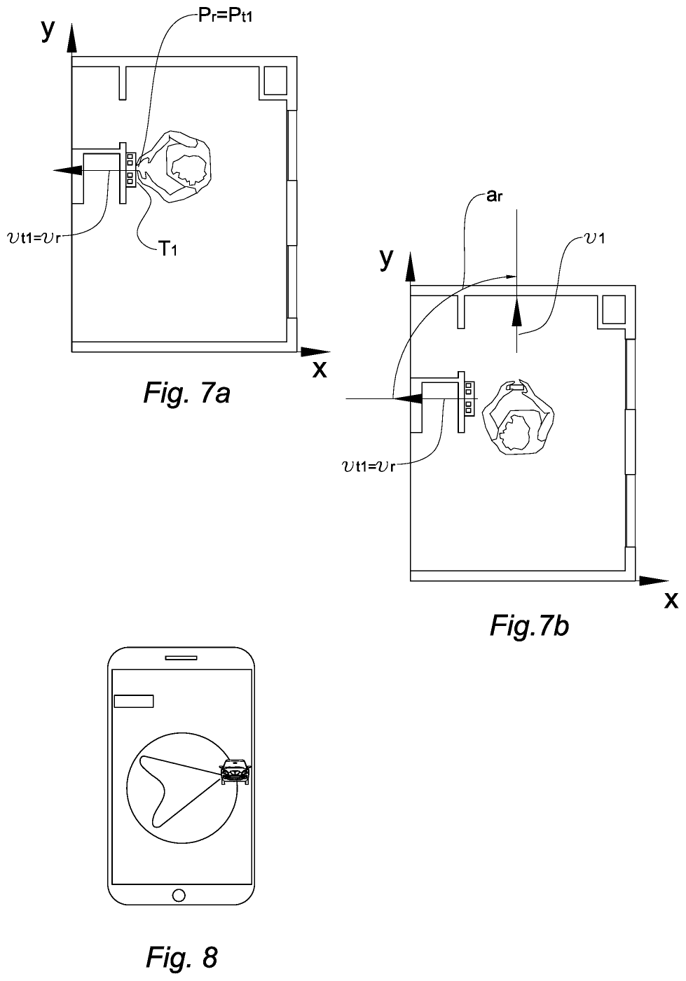

FIGS. 7a and 7b show an example of the step for acquiring and measuring the angle of in a process according to the invention;

FIG. 8 shows an example of operation of a smartphone according to a step of directing a process according to the invention.

Preliminarily, it should be noted that the term “versor” used in this text means a unitary module vector which characterises an orientation, that is, a direction and a sense, and which is free of a specific application point.

The term “vector” means the product of a versor for a module, which defines the extent of the quantity represented by the vector, applied to an application point from which it extends in the direction and in the sense defined by said versor.

With particular reference to the above-mentioned drawings, a process for reconstructing the movement of an individual who walks inside a space and who carries a device equipped with sensors at least inertial, but preferably at least also optical, audio, radiofrequency, magnetic etc, and a virtual representation M which is representative of said space, according to the invention has a peculiarity in that it comprises, in general and as described in more detail below, the following steps:
an acquisition step;
a detection step;
a reconstruction step;
an estimation step.

Said device is preferably a portable electronic device such as a smartphone or the like, and is advantageously equipped with a graphic interface which allows information to be provided to an individual who carries it.

Moreover, the device preferably has an interactive interface which allows data to be entered by an individual who uses it where the interactive interface and the graphic interface are advantageously integrated in a single graphic-interactive interface such as a touch screen.

According to the invention, the acquisition step comprises recording in the virtual representation M, by means of the device, a first reference position Pr1 and by choice:
a first reference versor vr1 associated with the first reference position Pr1 an, if necessary, an alignment angle af which consists in the angle formed by the direction of movement of the individual with the first reference versor vr1, in the reference position Pr1, where the direction of movement is that of arrival at the reference position Pr1 or of departure from the latter,
   or
a second reference position Pr2.

Said direction of movement can be the actual direction, if the user is already moving, or a presumed direction, for example, if the user is stationary and is about to start the movement.

According to the acquisition step it can be, for example, the individual who carries the device to enter into the latter the data relative to the first reference position Pr1, the first reference direction vr1 and the alignment angle af or the second reference position Pr2.

For example, the device can be equipped with a touch screen on which to display the virtual representation M of the space in which the individual is located. The data entry can therefore, for example, be actuated by touching the image of the virtual representation on the touch screen to enter the first reference position Pr1 or the second reference position Pr2. The first reference direction vr1 can be entered, for example, by dragging a finger on the touch screen starting from the second reference position Pr1 so as to provide a direction to acquire as first reference direction vr1 and which corresponds to the direction of motion which the user intends to follow. Advantageously, in this case, it might not be necessary to specify the amount of the alignment angle of as the latter is equal to zero if the orientation of the device with respect to the direction of walking is fixed and known in advance. Moreover, according to the acquisition step, the individual can, for example, use traditional software methods based also on computer vision or on augmented reality, currently provided through the use of commercial smartphones, to enter the data relative to the first reference position using said traditional techniques.

For example, the device can use the traditional software library ArCore (if it is an Android device, https://developers.google.com/ar/discover/) or the traditional software library ArKit (if it is an Apple device, https://developer.apple.com/arkit/) which allow the position and the orientation of the individual to be obtained expressed in a system of internal coordinates and which, through the acquisition step, are associated with the first reference position Pr1,vr1 or the second reference position Pr2,vr2. Advantageously, the use of this further traditional method allows increases in performance to be obtained during the reconstruction step since it allows any integration drift on the estimation of the position to be limited, linked, for example, to the use of gyroscopic sensors. Alternatively, the acquisition step can comprise the use of alignment elements as described in more detail below.

The detection step, according to the invention, comprises detecting, by means of the inertial sensors of the device, a direction of movement for each step made by the individual, with respect to a reference system of the device. The detection step can also comprise the detection, rather than the insertion, of the alignment angle of which can be calculated by the device by means of inertial sensors following the estimation of a rotation which aligns the versor relative to the actual direction of motion of the individual either
from a relative direction of arrival to the reference position Pr1 to an orientation parallel to the reference versor vr1,
   or
from an orientation parallel to the reference direction vr1 to a relative direction of movement in the t for moving from the reference position Pr1. FIG. 7a shows the reading step of an alignment element. Following this reading, the alignment vr of said alignment element is used to start the setting up of the device designed for the reading of said element. Advantageously, if the reading is carried out by keeping the device parallel to the exposed face of the alignment element and the latter is positioned vertically with respect to the horizontal plane (roll=90°, pitch=0°) then said alignment attitude, represented with a trio of Euler angles, will be equal to (roll, pitch, heading)=(90°, 0°, vr).

Following the reading of the alignment element the user is positioned, for example, in such a way as to start the walk (as shown by way of example in FIG. 7b) therefore performing, for example, a rotation equal to af=90° starting from said initial alignment vr to an overall heading equal to vr+af, subsequently used to represent the vectors V1 . . . Vn forming the trajectory. A traditional method for calculating of using the measurements coming from gyroscope and from the knowledge of the initial attitude is described in the first part of “Euler Angle Based Attitude Estimation Avoiding the Singularity Problem”, Chul Woo Kang, Chan Gook Park, in Proceedings of the 18th World Congress The International Federation of Automatic Control Milano (Italy) Aug. 28-Sep. 2, 2011.

Generally, a possible representation of the orientation is given by the knowledge of a trio of roll (φ, phi), pitch (θ, theta), heading (ψ, psi) angles. The initial roll and pitch angles in this case are obtained from the reading of the alignment element but they can generally be calculated starting from measurements coming from an accelerometer as described by Sergiusz Luczak et al. in “Sensing Tilt With MEMS Accelerometers”, IEEE Sensors Journal, Volume 6, Issue 6, Pages 1669-1675, December 2006, ISSN 1530-437X.

In particular, if the initial orientation is that obtained from the reading of the alignment element and consists of the values

$${attitude}_{initial} = [ \begin{matrix}{ϕ}_{i} \\ {θ}_{i} \\ {ψ}_{i}\end{matrix} ]$$

then at each sampling instant corresponding to the obtaining of a gyroscope measurement ω=(p, q, r) where p, q, r are the rotation speeds, at time t, respectively about the axes x, y and z of the device it is possible to proceed with the updating of said initial attitude using the following relationship:

$$rotationRates = [ \begin{matrix}p + r * cos ( ϕ ) * tan ( θ ) + q * sin ( ϕ ) * tan ( θ ) \\ q * cos ( ϕ ) - r * sin ( ϕ ) \\ \frac{r * cos ( ϕ )}{cos ( θ )} + \frac{q * sin ( ϕ )}{cos ( θ )}\end{matrix} ]$$

where Ts is the sampling time and at the initial instant attitude_{precedent}=attitudeᵢₙᵢₜᵢₐₗ, otherwise recursively attitude_{precedent}attuale=attitude_{current}passato.

At the end of the rotation, that is to say, when the user is in a position parallel to the direction in which he/she starts the walk, the value Pc corresponds to the sum vr+af.

Another traditional method which can be used for calculating af can, for example, use the traditional software libraries ArCore and ArKit, mentioned above, which can provide a measurement of the rotation starting from the analysis of the consecutive photograms taken by the camera of the smartphone (virtual gyroscope).

A basic description of this traditional tool is covered in Wilfried Hartmann, Michal Havlena, Konrad Schindler, “Visual Gyroscope for Accurate Orientation Estimation”, 2015 IEEE Winter Conference on Applications of Computer Vision.

In particular, the device will be advantageously configured for measuring the inertial pulses deriving from the impact of the feet with the ground, which identify the steps taken, and associating, for each pulse measured, the movement direction detected by means of the inertial sensors so as to detect the event corresponding to a step of the individual and the direction in space of the step.

Advantageously, if it is possible to use traditional software methods based on the “computer vision” such as, for example, ArCore and ArKit, then the estimate of the length of the step mentioned under the previous paragraph can be calculated fully, or improved in terms of accuracy, by implementing traditional “Visual Odometry” techniques such as, for example, that described by David Nister, Oleg Naroditsky, James Bergen in “Visual Odometry”, Proceedings of the 2004 IEEE Computer Society Conference on Computer Vision and Pattern Recognition, 2004. CVPR 2004.

Similarly, the precision of the direction of said step can be calculated fully, or improved in terms of accuracy, by using said traditional virtual gyroscope techniques.

Preferably, the device will be advantageously configured for measuring, through the use of traditional methods and the use of standard sensors such as accelerometers, gyroscopes and magnetometers, the inertial quantities deriving from the impact of the feet with the ground, which identify the steps taken and the amount of the rotations about the axis perpendicular to the horizontal plane, and associating, for each measurement, preferably both the direction and sense of movement measured and the amount of the movement corresponding to the taking of a step by the individual.

The direction and the sense of movement measured represent a two-directional vector identified by module (amount of the movement, that is, length of the step) and phase (direction in space of the step), which therefore consists in the above-mentioned direction of movement, as represented by vectors V1 . . . Vm of FIG. 2.

The reconstruction step comprises, in the virtual representation, a trajectory 100 representing a path followed by the individual walking, such as that shown, for example, in FIG. 2.

This reconstruction step comprises in particular generating the trajectory 100 as a sequence of vectors V1, V2 . . . Vm which extend from a starting point Po, from which a first vector V1 of said sequence extends, to an arrival point Pm, at which a last vector Vm of said sequence ends.

Advantageously, the intermediate vectors, between the first and last of the sequence, are interconnected in such a way that the condition applies by which the application point of each intermediate vector corresponds to the end point of a previous one of the intermediate vectors.

Each of the vectors V1, V2 . . . Vm is generated following the detection of a step of the individual and has an assigned module Ma and an assigned versor v1, v2, vm which is given by the direction of movement detected in the detection step for said step.

In other words, the vectors V1, V2 . . . Vm are generated following the detection of a step of the individual and have an assigned module Ma, which may be constant or variable, and an assigned versor v1, v2 . . . vm such that each vector V1 . . . Vm is equivalent in phase to the versor which identifies, step by step, the direction of movement of the user, that is to say, the above-mention direction of movement, detected in the detection step for said step.

Advantageously, if the relative orientation between the device and the user is assumed to be known and fixed in advance, then the direction of movement can be determined simply, for example if the device is held in the hand, in front of the user, in “portrait mode” and if the user walks forwards, then the direction of movement corresponds to the difference in attitude between the orientation of the device and the virtual system M.

The assigned module Ma preferably has a same value for all the vectors V1, V2, Vm of the sequence.

In other words, the length of the step of the user is predefined and has a value assigned in advance which can be, for example, a value of between 60 to 80 cm.

As described in more detail below, the average length of the step of the user can be estimated by means of the process according to the invention, allowing the assigned module Ma to be calibrated by assigning a value equal to that estimated.

If the relative orientation between device and user is not known and fixed in advance then the step v1, v2 . . . vm of each vector V1 . . . Vm representing the direction of motion of a step can be, for example, estimated according to the method described in patent document WO2017158633 which is hereby incorporated by reference. For example, the identification of the steps can be carried out by means of the technique described in “Pedestrian Dead Reckoning Based on Frequency Self-Synchronization and Body Kinematics”, Michele Basso, Matteo Galanti, Giacomo Innocenti, and Davide Miceli, in IEEE SENSORS JOURNAL, VOL. 17, NO. 2, Jan. 15, 2017.

The above-mentioned technique comprises measuring the steps of a user at peaks of the acceleration measured along the vertical component and also describes a traditional method for reconstructing the inertial trajectory. Advantageously, where available, the device can use said traditional virtual gyroscope and virtual odometry techniques or said traditional software libraries ArCore and ArKit for calculating fully or improving the estimation of, respectively, said length of the step and said relative orientation between device and user.

The estimation step, according to the invention, comprises positioning said trajectory 100 in the virtual representation M in such a way that, selectively:
the staring point Po coincides with the first reference position Pr1 and the arrival point Pm coincides with the second reference position Pr2 for obtaining an estimate of the assigned module Ma as specified in detail below;
   or
in such a way that the starting point Po, or the arrival point Pm, coincides with the first reference position Pr1 and the assigned versor v1 of the first vector V1, or the assigned versor vm of the last vector Vm respectively, coincides with the first reference versor vr1 apart from an alignment angle af detected in the detection step or entered in the acquisition step, to obtain an estimate of the arrival point Pm or of the starting point Po respectively.

The alignment angle af is defined as the angle between the first reference versor vr1 and the assigned versor v1 of the first vector V1 or the assigned versor vm of the last vector Vm respectively.

A first embodiment of the process according to the invention is particularly useful, for example, for guiding an individual to the place in which he/she has left their relative vehicle in a very large area, especially a covered car park. The first embodiment is described below with reference to FIGS. 3-6.

The process advantageously comprises also a preparation step which, in general, comprises positioning in the space at least one alignment element to which is uniquely associated an identifier.

Advantageously, the preparation step comprises positioning in the space a plurality of alignment elements, each of which is uniquely associated with an identifier.

FIG. 3 shows, by way of a non-limiting example, a case which comprises the installation of three alignment elements respectively indicated with references T1, T2 and T3 which are assumed to correspond to the respective identifiers.

The process, and advantageously the preparation step, preferably also comprise a recording step which comprises recording in the virtual representation M for each of the alignment elements T1, T2, T3 an alignment position respectively indicated with the references Pt1, Pt2, Pt3.

The alignment position Pt1, Pt2, Pt3 represents, in the virtual representation M, the position which the corresponding alignment element T1, T2, T3 has in the actual space, represented in a Cartesian reference system associated with the latter.

Preferably, each alignment element T1, T2, T3 comprises a tag applied to a vertical surface and legible by the device which preferably comprises reading means for reading the tag.

In this case, the tag is deemed to mean any form of element designed to bear information especially on the identifier of the alignment element in question. In other words, the tag can have, for example, a bar code or a QR code, in which case the reading by the electronic device will be optical.

Or the tag can comprise an NFC tag (Near Field Communication), in which case the reading will be carried out by means of an electromagnetic field. The tag in accordance with a particularly simple embodiment is preferably flat, advantageously vertical and has a face exposed towards the space so that the device can be placed in front of it.

In general, the device preferably comprises reading means suitable for the reading of the tag for detecting from it the identifier of the alignment element and thereby acquire the relative alignment position and, if necessary, also the alignment orientation of the tag, as described below.

Advantageously, the acquisition step comprises an association step which comprises associating with the first reference position Pr1 an alignment position Pt1, Pt2 or Pt3 of a selection between the alignment elements T1, T2 or T3 by:
positioning the device in a suitable fashion to read the identifier of the selected alignment element T1, T2 or T3 by means of the device;
reading the identifier of the selected alignment element T1, T2 or T3 by means of the device;
associating to the first reference position Pr1 the alignment position Pt1, Pt2 or Pt3 of the alignment elements T1, T2 or T3 of which the identifier has been read.

In other words, by means of the positioning of the device for reading the selected alignment element T1, T2 or T3, the reading of the identifier and the association of the first reference position with that of the alignment element corresponding to the identifier read, the advantageous use of the selected alignment element T1, T2 or T3 for recovering the position and orientation information from the virtual representation M.

The implementation of the acquisition step makes it possible not to request the user to enter the first reference position Pr1 and possibly the reference position Pr2 or the first reference direction vr1, for example by means of said entering carried out by means of the device and especially by means of a touch screen interface as described above.

In other words, the association step comprises assuming that the first reference position Pr1 coincides with that of the selected alignment element which, in the example of FIGS. 4 and 5 is the alignment element with identifier T2.

According to the first embodiment, the recording step advantageously comprises also recording, in the virtual representation M, an alignment orientation Ot1, Ot2, Ot3 for each alignment element T1, T2, T3.

The alignment orientation Ot1, Ot2, Ot3 represents, in the virtual representation M, the orientation which the corresponding alignment element T1, T2, T3 adopts in the reference system used for representing the actual space.

In this case, the association step comprises associating with the first reference versor vr1 the alignment orientation Ot1, Ot2, Ot3 of the selected alignment element T1, T2, T3 following the reading of the identifier of the alignment element T1, T2, T3.

Moreover, the association step comprises assuming as the point of application of the del versor vr1 the position Pt1, Pt2, Pt3 of said selected alignment element T1, T2, T3.

In other words, with reference to the example of FIGS. 4 e 5, the first reference versor vr1 is assumed to be the alignment orientation Ot2 of the alignment element with identifier T2, with application point corresponding to Pt2.

The association step advantageously comprises positioning the device according to a predetermined attitude with respect to the selected alignment element T1, T2, T3 for carrying out the reading of the identifier of the alignment element T1, T2, T3 by means of the device.

This predetermined alignment of the device, for reading the tag, preferably consists in a position in front of and facing the alignment element and, especially, the tag.

For example, in the preferred case in which the device consists of a smartphone, said predetermined attitude will consist of the so-called “portrait mode” wherein the smartphone is positioned in front of the tag with the screen substantially parallel to the tag.

With reference to the example illustrated in FIGS. 3-5, the association step will comprise the reading, by means of the device carried by the individual, of the tag of the alignment element T2.

Advantageously, the recording step comprises recording the alignment position Pt1, Pt2 or Pt3 in the form of coordinates (Pt1x, Pt1y), (Pt2x, Pt2y) and (Pt3x, Pt3y) with respect to a Cartesian reference system C(X,Y) associated with the virtual representation M.

If the virtual representation M is used in contexts where it is necessary to also identify a level Z such as, for example, the storey of a building the Cartesian reference system C(X,Y) preferably also comprises a third additional coordinate Z which can be used for identifying the vertical level of the virtual representation M to which the alignment elements T1, T2, T3 refer. The alignment orientation Ot1, Ot2, Ot3 is preferably associated with an angle formed by a reference versor vt1, vt2, vt3 which is associated with the alignment element T1, T2, T3 and a selected axis of said Cartesian reference system, for example the axis X, where the reference versor vt1, vt2, vt3 is advantageously considered applied to the alignment position Pt1, Pt2, Pt3 of the corresponding alignment element T1, T2, T3.

The reference versor vt1, vt2, vt3 is generally a versor representing the orientation of the respective alignment element T1, T2, T3 in the space. For example, in the embodiment in which the alignment elements T1, T2, T3 are flat tags and provided with a face exposed to the space, the reference versor vt1, vt2, vt3 will advantageously have a direction and a sense, where the direction consists in the projection on the horizontal plane of a direction perpendicular to the face of the corresponding tag and the sense will be that of a versor entering in the exposed face of the tag.

In FIG. 3, convenience of description, the reference of the corresponding alignment orientation Ot1, Ot2, Ot3 is associated with said angle.

In the above-mentioned first embodiment, the estimation step, according to the invention, advantageously comprises positioning the trajectory 100 in such a way that the arrival point Pm coincides with the alignment position Pt1, Pt2 or Pt3 of the selected alignment elements T1, T2, T3.

Therefore, in the example of FIG. 4, the arrival point Pm is advantageously located at the alignment position Pt2 of the alignment element having identifier T2.

According to the first embodiment, the alignment angle af will be the angle detected by the device in its rotation until moving the device (and, if necessary, the individual) according to an orientation parallel to the first reference versor vr1.

Therefore, in the estimation step, the trajectory ill be rotated in such a way that assigned direction vm of the last vector Vm of the trajectory 100 coincides with the first reference direction vr1 apart from the alignment angle af.

That is to say, in the example of FIG. 3, where A is the angle of difference between the angle Ot2 associated with the selected alignment element T2, located at the position Pm, and the angle vm+af, each of the vectors V1, V2, . . . Vm will be rotated by means of a rotation matrix

$$R = [ \begin{matrix}cos ( A ) & - sin ( A ) \\ sin ( A ) & cos ( A )\end{matrix} ]$$

so as to obtain the vectors W1, W2, . . . , Wm as W1=R*V1, W2=R*V2, . . . , Wm=R*Vm.

The sequence which ends with Wm which points to Pt2 and which has intermediate vectors interconnected in such a way that the condition applies by which the point of application of an intermediate vector corresponds to the end point of a previous intermediate vector represents the above-mentioned trajectory rotated.

This provides the position of the starting point Po which is recorded in the virtual representation M to be made available to the individual for subsequently providing to the latter the navigation information for reaching the starting point Po.

According to the above-mentioned example according to which the point Po represents the point in which the individual has left his/her vehicle in a car park, thanks to the process according to the invention the device will provide an estimation of the position of the starting point Po in the virtual representation M and can therefore subsequently provide to the user information for returning to the starting point Po starting from any point of the virtual representation, for example from a point from which to read the identifier of any alignment element T1, T2 or T3.

In general, in accordance with said first embodiment of the process according to the invention, the estimation step comprises positioning the trajectory 100 in the virtual representation in such a way that the arrival point Pm coincides with the first reference position Pr1 and the assigned direction vm of the last vector Vm coincides with the first reference direction vr1.

In that case, the estimation step comprises recording the position which, in the virtual representation M, it is adopted by the starting point Po of the trajectory 100.

Preferably, the process according to the invention comprises a direction step which comprises presenting to the individual information, such as, for example, that shown in FIG. 8, for reaching said starting position Po from a current position which comprises:
a first step which comprises positioning the device in a suitable fashion to read the identifier of one of the alignment elements T1, T2, T3, reading the identifier by means of the device and associating to the current position, in the virtual representation M, the alignment position Pt1, Pt2, Pt3 of the alignment element T1, T2, T3 corresponding to the identifier read;
a second step which comprises presenting to the individual, by means of the device, instructions suitable to reach the starting point Po starting from the current position, as shown, for example, in FIG. 8.

Advantageously, the direction step also comprises a third step, after the second step.

The third step comprises updating the current position in the virtual representation M as a function of movement signals provided by the inertial sensors following a movement of the individual from the alignment position Pt1, Pt2, Pt3, and providing instructions suitable to reach the starting point Po starting from the updated current position.

In general, however, the difference between the value of the assigned module Ma and real average length of the steps made by the individual between the staring point Po and the arrival point Pm will determine a discrepancy between the trajectory 100 detected in the reconstruction step and the real movement of the individual which has lead him/her to the alignment element T1, T2 or T3 identified.

There will therefore be a discrepancy, generally negligible, between the position recorded in the estimation step and the real position from which the individual has moved to carry out the above-mentioned real movement.

In order to eliminate this possible discrepancy it is possible to carry out a calibration or, as described in more detail below, a calibration which assigns to the assigned module Ma an estimated value for the specific individual and not a predetermined value.

For this purpose, in general, the preparation step preferably comprises positioning in said space at least a first T1 and a second T2 of the alignment elements T1, T2, T3.

The process according to the invention also advantageously comprises a calibration step which comprises:

A) carrying out the acquisition step both for the first alignment element T1 and for the second alignment element T2;
B) positioning the device in a suitable fashion to read the identifier of the first alignment element T1 by means of the device;
C) reading the identifier of the first alignment element T1 by means of the device;
D) performing steps B and C also for the second alignment element T2;
E) positioning in the virtual representation M the arrival point Pm of the trajectory 100 in such a way as to coincide with the alignment position Pt2 of the second alignment element T2;
F) assigning to the assigned module Ma of the vector V1, V2 . . . Vm a value (preferably equal for all the vectors V1, V2 . . . Vm) so that the starting point Po coincides with the alignment position Pt1 of the first alignment element T1.

Advantageously, the direction step comprises reading, in succession, the identifiers of a plurality of the alignment elements T1, T2, T3 following the movement of the user.

In other words, whilst the user walks following the instructions of the device he/she can pass close to alignment elements where the identifier can be read, thereby updating the relative actual position and therefore allowing device to provide more precise instructions.

Clearly, the above-mentioned calibration step can occur simultaneously with the direction step, thereby allowing recalibration of the length of the step of the user following the reading of the identifiers of two successive alignment elements.

Advantageously, the virtual representation M will be geolocated in a global virtual representation G by means of a reference position Pg and an orientation which is advantageously given by an angle ax between a reference direction of the virtual representation M, which can be, for example, the axis X, and an orientation direction which can be the direction of the magnetic north N.

In this way it will be possible, by means of the process described above, to geolocate the starting position Po with respect to the global virtual representation G.

According to a second embodiment of the invention, during the estimation step, the positioning of the trajectory 100 in the virtual representation M in such that the starting point Po coincides with the first reference position Pr1 and the assigned direction v1 of the first vector V1 coincides with the first reference direction vr1, the estimation step comprises recording the position which, in the virtual representation M, it is adopted by the arrival point Pm of the trajectory 100.

According to a third embodiment of the invention, the process according to the invention allows the associated module Ma to be calibrated so as to allow the implementation of a simultaneous localisation and mapping function (SLAM), by means of sensors which are preferably magnetic but which, alternatively, can be radiofrequency sensors, optical sensors and similar sensors, with which the device is advantageously equipped.

In accordance with said third embodiment, the preparation step advantageously comprises positioning in the space at least a first T1 and a second T2 of said alignment elements T1, T2, T3.

The estimation step comprises positioning the trajectory 100 in the virtual representation M in such a way that the staring point Po coincides with the first reference position Pr1 and the arrival point Pm coincides with the second reference position Pr2.

The acquisition step preferably comprises associating the alignment position Pt1 of the first alignment element T1 with the first reference position Pr1 and the alignment position Pt2 of the second alignment element T2 with the second reference position Pr2 by:
positioning the device in a suitable fashion to read the identifier of the first alignment element T1;
reading the identifier of the first alignment element T1, by means of the device;
positioning the device in a suitable fashion to read the identifier of the second alignment element T2;
reading the identifier of the second alignment element T2, by means of the device;
reading the identifier of the second alignment element T2, by means of the device.

Clearly, during the movement of the user between the first and the second alignment element, the device, by means of the process according to the invention, can estimate in real time the position of the user, just like in the first or in the second embodiment described above, and, at the same time, record the signals coming from the sensors.

In other words, a process according to the invention can comprise the combination of the above-mentioned embodiments.

The process also advantageously comprises a calibration step which associates to the assigned module Ma of the vectors V1, V2, Vm a value such that the starting point Po coincides with the first reference position Pr1 and the arrival point Pm coincides with the second reference position Pr2. According to the process, preferably after carrying out said calibration step, that is to say, the matching of the trajectory calculated on real one, the signals read during the walk can only be correctly georeferenced after the event, and, therefore, the map constructed.

As an alternative to the use of the alignment elements, as explained above, according to the acquisition step it can be, for example, the individual who carries the device to enter into the latter the data relative to the first reference position Pr1, and the second reference position Pr2. Clearly, in this case, the above-mentioned preparing step may be omitted.

The invention as it is conceived is susceptible to numerous modifications and variants, all falling within the scope of protection of the appended claims. Further, all the details can be replaced by other technically-equivalent elements. In practice, the materials used, as well as the contingent forms and dimensions, can be varied according to the contingent requirements and the state of the art.

Where the constructional characteristics and the technical characteristics mentioned in the following claims are followed by signs or reference numbers, the signs or reference numbers have been used only with the aim of increasing the intelligibility of the claims themselves and, consequently, they do not constitute in any way a limitation to the interpretation of each element identified, purely by way of example, by the signs or reference numerals.

1. A process for reconstructing the movement of an individual who walks inside a space and who carries a device equipped with inertial sensors and a virtual representation (M) which represents said space;
said process being characterised in that it comprises:
an acquisition step which comprises recording in said virtual representation, by means of said device, a first reference position (Pr1) and by choice: a first reference versor (vr1) associated with said first reference position (Pr1) or a second reference position (Pr2);
a detection step which comprises detecting, by means of said inertial sensors, a movement versor for each step made by said individual, with respect to a reference system of said device;
a reconstruction step which comprises forming, in said virtual representation, a trajectory (100) representing a path followed by said individual; said reconstruction step generating said trajectory (100) as a sequence of vectors (V1, V2, Vm) which extend from a starting point (Po), from which a first vector (V1) of said sequence extends, to an arrival point (Pm), at which a last vector (Vm) of said sequence ends;
where each of said vectors (V1, V2, Vm) is generated following the detection of a step of said individual and has an assigned module (Ma) and an assigned direction (v1, v2, vm) which is given by the movement versor detected in said detection step for said step; said assigned module (Ma) has a same value for all the vectors (V1, V2, Vm) of said sequence;
an estimation step;
said estimation step comprises positioning said trajectory (100) in said virtual representation (M) in such a way that, selectively:
said starting point (Po) coincides with said first reference position (Pr1) and said arrival point (Pm) coincides with said second reference position (Pr2) to obtain an estimate of said assigned module (Ma);
said starting point (Po), or said arrival point (Pm), coincides with said first reference position (Pr1) and the assigned direction (v1) of said first vector (V1), or the assigned direction (vm) of said last vector (Vm), respectively, coincides with said first reference direction (vr1) apart from an alignment angle (af) detected in said detection step or inserted in said acquisition step; said alignment angle (af) being formed between said first reference direction (vr1) and the assigned direction (v1) of said first vector (V1) or the assigned direction (vm) of said last vector (Vm) respectively.

2. The process according to claim 1, characterised in that it comprises:
a preparation step which comprises positioning in said space at least one alignment element (T1, T2, T3) to which is uniquely associated an identifier;
a recording step which comprises recording in said virtual representation (M) and alignment position (Pt1, Pt2, Pt3) for each of said at least one alignment elements (T1, T2, T3), where said alignment position (Pt1, Pt2, Pt3) represents, in said virtual representation (M), the position which said alignment element (T1, T2, T3) has in said space.

3. The process according to claim 2 characterised in that each of said at least one alignment element (T1, T2, T3) comprises a tag applied to a vertical surface and legible by said device; said device comprising means for reading said tag.

4. The process according to claim 2 characterised in that said acquisition step comprises an association step which associates an alignment position (Pt1, Pt2, Pt3) of a selection of said at least one alignment element (T1, T2, T3) to said first reference position (Pr1) by:
positioning said device in a suitable fashion to read the identifier of said selected alignment element (T1, T2, T3) by means of said device;
reading the identifier of said selected alignment element (T1, T2, T3) by means of said device.

5. The process according to claim 2 characterised in that according to said acquisition step it is the individual who carries said device enters in the latter the data relative to said first reference position (Pr1), to said first reference direction (vr1) and, if necessary, to said alignment angle (af).

6. The process according to claim 4 characterised in that said recording step also records in said virtual representation (M) an alignment orientation (Ot1, Ot2, Ot3) for each of said at least one alignment element (T1, T2, T3), where said alignment orientation (Ot1, Ot2, Ot3) represents, in said virtual representation (M), the orientation which said alignment element (T1, T2, T3) has in said;
said association step also comprising associating to said first reference direction (vr1) the alignment orientation (Ot1, Ot2, Ot3) of said selected alignment element (T1, T2, T3) following the reading of the identifier of said alignment element (T1, T2, T3); where said association step comprises positioning said deice according to a predetermined attitude with respect to said selected alignment element (T1, T2, T3) to carry out said reading of the identifier of said at least one alignment element (T1, T2, T3) by means of said device.

7. The process according to claim 6 characterised in that said recording step comprises recording said alignment position (Pt1, Pt2, Pt3) in the form of coordinates (Pt1x, Pt1y), (Pt2x, Pt2y), (Pt3x, Pt3y) with respect to a Cartesian reference system C(X,Y) associated with said virtual representation (M), said alignment orientation (Ot1, Ot2, Ot3) being associated with an angle formed by a reference versor (vt1, vt2, vt3) associated with said alignment element (T1, T2, T3) and a selected axis (X) of said Cartesian reference system C(X,Y).

8. The process according to claim 7 characterised in that said tag is flat and has a face exposed to said space, said reference versor (vt1, vt2, vt3) having a direction and a sense, where said direction consists in the projection on a horizontal plane of a direction perpendicular to the face of said tag and said sense is facing towards the face of said tag.

9. The process according to claim 5 characterised in that following the positioning of said trajectory (100) in said virtual representation in such a way that said arrival point (Pm) coincides with said first reference position (Pr1) and the assigned direction (v1) of said last vector (Vm) coincides with said first reference direction (vr1), said estimation step comprises recording the position which, in said virtual representation (M), it is adopted by the starting point (Po) of said trajectory (100).

10. The process according to claim 9 characterised in that it comprises a direction step which comprises presenting to said individual information for reaching said starting position (Po) from a current position which comprises:
a first step which comprises positioning said devise in a suitable fashion to read the identifier of one of said at least one alignment element (T1, T2, T3), reading said identifier by means of said device and associating to said current position, in said virtual representation (M), the alignment position (Pt1, Pt2, Pt3) of the alignment element (T1, T2, T3) corresponding to said identifier;
a second step which comprises presenting to said individual, by means of said device, instructions suitable to reach said starting point (Po) starting from said current position.

11. The process according to claim 10 characterised in that said direction step comprises a third step, following said second step; said third step comprising updating said current position in said virtual representation (M) as a function of movement signals provided by said inertial sensors following a movement of said individual from said alignment position (Pt1, Pt2, Pt3), and providing instructions suitable to reach said starting point (Po) starting from said updated current position.

12. The process according to claim 5 characterised in that, following the positioning of said trajectory (100) in said virtual representation (M) in such a way that said starting point (Po) coincides with said first reference position (Pr1) and the assigned direction (v1, v2, vm) of said first vector (V1) coincides with said first reference direction (vr1), said estimation step comprises recording the position which, in said virtual representation (M), it is adopted by the arrival point (Pm) of said trajectory (100).

13. The process according to claim 2 characterised in that said preparation step comprises positioning in said space at least one first alignment element (T1) and a second alignment element (T2) of said at least one alignment element (T1, T2, T3);
where said estimation step comprises positioning said trajectory (100) in said virtual representation (M) in such a way that said staring point (Po) coincides with said first reference position (Pr1) and said arrival point (Pm) coincides with said second reference position (Pr2);
where said acquisition step comprises associating the alignment position (Pt1) of said first alignment element (T1) with said first reference position (Pr1) and the alignment position (Pt2) of said second alignment element (T2) with said second reference position (Pr2) by:
positioning said device in a suitable fashion to read the identifier of said first alignment element (T1) by means of said device;
reading the identifier of said first alignment element (T1) by means of said device;
positioning the device in a suitable fashion to read the identifier of said second alignment element (T2);
reading the identifier of said second alignment element (T2) by means of said device;
said process also comprising a calibration step which assigns to the assigned module (Ma) of said vectors (V1, V2, Vm) a value such that said starting point (Po) coincides with said first reference position (Pr1) and said arrival point (Pm) coincides with said second reference position (Pr2).

14. The process according to claim 2 characterised in that according to said acquisition step it is the individual who carries said device to enter in the latter the data relative to said first reference position (Pr1), and to said second reference position (Pr2);
where said estimation step comprises positioning said trajectory (100) in said virtual representation (M) in such a way that said staring point (Po) coincides with said first reference position (Pr1) and said arrival point (Pm) coincides with said second reference position (Pr2);
said process also comprising a calibration step which assigns to the assigned module (Ma) of said vectors (V1, V2, Vm) a value such that said starting point (Po) coincides with said first reference position (Pr1) and said arrival point (Pm) coincides with said second reference position (Pr2).
